(19) United States
(12) Patent Application Publication
(10) Pub. No.: US 2024/0323398 A1
(43) Pub. Date: Sep. 26, 2024

(54) TECHNIQUES FOR PERFORMING DIRECTIONAL INTRA PREDICTION WHEN ENCODING MEDIA CONTENT

(71) Applicant: NETFLIX, INC., Los Gatos, CA (US)

(72) Inventor: Aleix SEGUI UGALDE, Barcelona (ES)

(21) Appl. No.: 18/609,993

(22) Filed: Mar. 19, 2024

Related U.S. Application Data
(60) Provisional application No. 63/491,519, filed on Mar. 21, 2023.

(51) Int. Cl. H04N 19/159; H04N 19/119; H04N 19/174

(52) U.S. Cl. CPC H04N 19/159; H04N 19/119; H04N 19/174

(57) ABSTRACT

In various embodiments, a directional intra prediction application encodes video or other media content. The directional intra prediction application transposes a left reference column of samples associated with a first portion of content to generate a left reference row of samples. The directional intra prediction application computes a transposed rightward predicted tile of samples based on a prediction angle and the left reference row of samples. The directional intra prediction application transposes the transposed rightward predicted tile to generate a rightward predicted tile of samples. The directional intra prediction application generates a predicted tile of samples for the first portion of content based on a downward predicted tile of samples and the rightward predicted tile of samples.

### CROSS-REFERENCE TO RELATED APPLICATIONS

This application claims priority benefit of the U.S. Provisional Patent Application titled, “PARALLEL ALGORITHM FOR DIRECTIONAL INTRA-PREDICTION,” filed on Mar. 21, 2023, and having Ser. No. 63/491,519. The subject matter of this related application is hereby incorporated herein by reference.

### BACKGROUND

### Field of the Various Embodiments

The various embodiments relate generally to computer science and media encoding technologies, more specifically, to techniques for performing directional intra prediction when encoding media content.

### Description of the Related Art

Efficiently and accurately encoding videos is an important aspect of streaming high-quality videos in real-time or in near-real-time. Typically, as an encoded version of a video is streamed to a playback device, the encoded video content is decoded to generate a reconstructed video that is played back on the playback device. To increase the degree of compression and, accordingly, reduce the size of encoded videos, encoders typically implement various data compression techniques. The data compression techniques are generally designed to eliminate certain selected information during the encoding process while ensuring that the visual quality of a reconstructed video derived from an encoded video remains at an acceptable level. In that regard, many encoders implement a data compression technique known as directional intra prediction, which is a technique that exploits spatial redundancy across the pixels of a given frame along a prediction angle so that other data compression techniques can then be used to reduce the number of bits representing the frame. In the context of directional intra prediction, a prediction angle that is diagonally downward and rightward across a frame corresponds to a directional intra prediction referred to as “directional intra prediction from zone 2.”

In one approach to encoding using directional intra prediction from zone 2, the pixels within a given frame are partitioned into rectangular blocks referred to as “macroblocks.” The macroblocks are sequentially encoded and decoded to generate, respectively, encoded macroblocks and reconstructed macroblocks. To encode a given macroblock, a reference row of values for pixels or “samples” is determined based on any number of reconstructed macroblocks that are located above the given macroblock. A left reference column of samples is determined based on any number of reconstructed macroblocks that are located to the left of the given macroblock. For each row of pixels within the given macroblock, samples from the reference row and the left reference column are interpolated downwards and rightwards along a prediction angle to compute a row of samples within a predicted macroblock. Subsequently, various other data compression techniques are used to generate an encoded macroblock based on the different predicted macroblocks.

One drawback of the above approach to directional intra prediction from zone 2 is that the processing efficiencies typically captured through parallel processing can be substantially reduced. In that regard, most encoders are configured to store the multi-dimensional arrays used to represent frames of videos in row-major order. When stored in row-major order, the sequential elements in a row of a given array are usually stored in contiguous memory locations, but the sequential elements in a column of that given array are usually stored in non-contiguous memory locations. As is well-understood, performing operations on data stored in non-contiguous memory locations is oftentimes substantially less efficient than performing those same operations on data stored in contiguous memory locations. Because the left reference samples are typically stored in non-contiguous memory locations when performing intra directional prediction from zone 2, any parallel processing operations used to generate a row within a predicted macroblock based on left reference samples usually execute with degraded efficiency. As a result, overall encoding throughput can be decreased when performing intra directional processing from zone 2 on video content and other media content (e.g., images)

As the foregoing illustrates, what is needed in the art are more effective techniques for performing intra directional prediction when encoding video or other media content.

### SUMMARY

One embodiment sets forth a computer-implemented method for encoding video or other media content. The method includes transposing a left reference column of samples associated with a first portion of content to generate a left reference row of samples; computing a transposed rightward predicted tile of samples based on a prediction angle and the left reference row of samples; transposing the transposed rightward predicted tile to generate a rightward predicted tile of samples; and generating a predicted tile of samples for the first portion of content based on a downward predicted tile of samples and the rightward predicted tile of samples.

At least one technical advantage of the disclosed techniques relative to the prior art is that, with the disclosed techniques, samples within a left reference column used to encode a given macroblock are reorganized into contiguous locations in memory to facilitate parallel processing when performing directional intra prediction from zone 2. In that regard, prior to computing a predicted macroblock, a left reference column associated with a given macroblock being encoded is automatically transposed to generate a left reference row. Because the samples within the left reference row can be stored in contiguous memory, processing efficiencies can be increased via parallel processing relative to what can be achieved using prior art techniques to compute the predicted macroblock. As a result, the disclosed techniques can increase overall encoding throughput when performing directional intra directional processing from zone 2 on video content or other media content. These technical advantages provide one or more technological advancements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a conceptual illustration of a system configured to implement one or more aspects of the various embodiments;

FIG. 2 is an exemplar illustration of a preprocessing process executed by the macroblock preprocessing engine of FIG. 1, according to various embodiments;

FIG. 3 is an exemplar illustration of a directional intra prediction process executed by the tile prediction engine of FIG. 1, according to various embodiments; and

FIG. 4 is a flow diagram of method steps for performing directional intra prediction from zone 2 when encoding video or other media content, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details. For explanatory purposes, multiple instances of like objects are symbolized with reference numbers identifying the object and parenthetical numbers(s) identifying the instance where needed.

A typical video streaming service provides access to a library of videos that can be viewed on a range of different client devices. To efficiently deliver videos to client devices, the video streaming service provider encodes the videos via a media preprocessing pipeline and then streams the resulting encoded videos to the client devices. Each client device decodes the stream of encoded video data and displays the resulting reconstructed video to viewers. To increase the degree of compression and, accordingly, reduce the size of encoded videos, a typical media processing pipeline implements various data compression techniques.

In particular, many media processing pipelines implement directional intra prediction from zone 2. Directional intra prediction from zone 2 is a data compression technique that exploits spatial redundancy across the pixels of a given frame along a prediction angle that is diagonally downward and rightward across the frame so that other data compression techniques can then be used to reduce the number of bits representing the frame.

In one approach to encoding using directional intra prediction from zone 2, the media processing pipeline partitions the pixels within a frame into rectangular macroblocks. The macroblocks are sequentially encoded and decoded to generate, respectively, encoded macroblocks and reconstructed macroblocks. To encode a given macroblock, a reference row of samples and a left reference column of samples is determined based on any number of reconstructed macroblocks that are located, respectively, above and to the left of the given macroblock. For each row of pixels within the given macroblock, samples from the reference row and the left reference column are interpolated downwards and rightwards along the prediction angle to compute a row of samples within a predicted macroblock. Subsequently, various other data compression techniques are used to generate an encoded macroblock based on at least the predicted macroblock.

One drawback to the above approach to directional intra prediction from zone 2 is that the processing efficiencies typically captured through parallel processing can be substantially reduced. In that regard, the left reference samples are typically stored in non-contiguous memory locations when performing intra directional prediction from zone 2. As is well-understood, performing operations on data stored in non-contiguous memory locations is oftentimes substantially less efficient than performing those same operations on data stored in contiguous memory locations. Consequently, any parallel processing operations used to generate a row within a predicted macroblock based on samples stored in the left reference column usually execute with degraded efficiency. As a result, overall encoding throughput can be decreased when performing intra directional processing from zone 2 on frames of videos.

With the disclosed techniques, however, an intra directional prediction application reorganizes samples within a left reference column used to encode a given macroblock into contiguous locations in memory to facilitate parallel processing when performing directional intra prediction from zone 2. In one embodiment, the intra directional prediction application determines an above reference row and a left reference column associated with a current macroblock based on any number of previously encoded and reconstructed macroblocks. The intra direction prediction application transposes the left reference column to generate a left reference row. Notably, the samples within the left reference row are stored in contiguous locations in memory. The intra direction prediction application partitions a current macroblock into square tiles and generates a different predicted tile for each of the tiles based on the above reference row, the left reference row, and a prediction angle. Subsequently, the intra direction prediction application aggregates the predicted tiles to generate a predicted macroblock for the current macroblock.

To generate a predicted tile for a current tile, the intra directional prediction application computes a downward predicted tile based on the above reference row and the prediction angle. The intra direction prediction application computes a transposed rightward predicted tile based on the left reference row and the prediction angle. The intra direction prediction application transposes the transposed rightward predicted tile to generate a rightward predicted tile. The intra direction prediction application merges the downward predicted tile and the rightward predicted tile based on the prediction angle to generate the predicted tile for the current tile.

At least one technical advantage of the disclosed techniques relative to the prior art is that, with the disclosed techniques, left reference samples used to encode a given macroblock are reorganized into contiguous memory locations in order to increase the efficiency of any parallel processing operations performed on the left reference samples during encoding. As a result, the disclosed techniques can increase overall encoding throughput when performing directional intra directional processing from zone 2 when encoding videos or other media content. These technical advantages provide one or more technological advancements over prior art approaches.

### System Overview

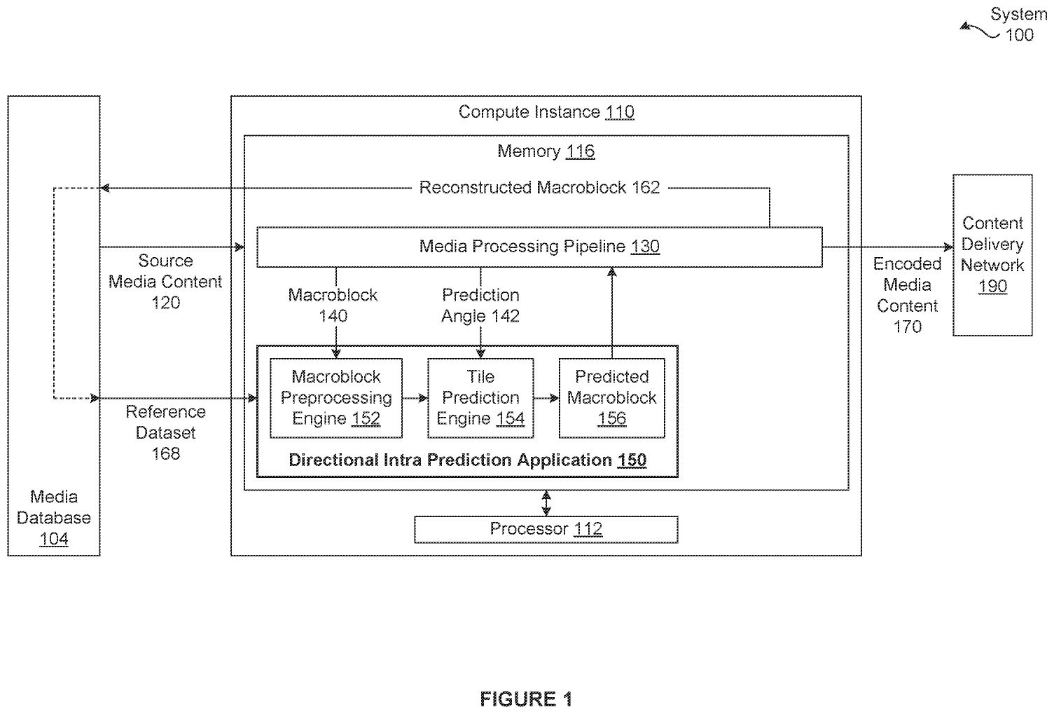

FIG. 1 is a conceptual illustration of a system 100 configured to implement one or more aspects of the various embodiments. As shown, in some embodiments, the system 100 includes, without limitation, a compute instance 110, a media database 104, and a content delivery network (CDN) 190.

In some other embodiments, the system 100 can omit one or more of the compute instance 110, the media database 104, the CDN 190, or any combination thereof. In the same or other embodiments, the system 100 can further include, without limitation, one or more other compute instances, one or more other media databases, one or more other CDNs, or any combination thereof.

Any number of the components of the system 100 can be distributed across multiple geographic locations or implemented in one or more cloud computing environments (e.g., encapsulated shared resources, software, data) in any combination. In some embodiments, the compute instance 110 and/or zero or more other compute instances can be implemented in a cloud computing environment, implemented as part of any other distributed computing environment, or implemented in a stand-alone fashion.

As shown, the compute instance 110 includes, without limitation, a processor 112 and a memory 116. In some other embodiments, each of any number of other compute instances can include any number of other processors and any number of other memories in any combination. In particular, the compute instance 110 and/or one or more other compute instances can provide a multiprocessing environment in any technically feasible fashion.

The processor 112 can be any instruction execution system, apparatus, or device capable of executing instructions. For example, the processor 112 could comprise a central processing unit, a graphics processing unit, a controller, a microcontroller, a state machine, or any combination thereof. The memory 116 stores content, such as software applications and data, for use by the processor 112. The memory 116 can be one or more of a readily available memory, such as random-access memory, read only memory, floppy disk, hard disk, or any other form of digital storage, local or remote.

In some embodiments, a storage (not shown) may supplement or replace the memory 116. The storage may include any number and type of external memories that are accessible to the processor 112 of the compute instance 110. For example, and without limitation, the storage can include a Secure Digital Card, an external Flash memory, a portable compact disc read-only memory, an optical storage device, a magnetic storage device, or any suitable combination of the foregoing.

In some embodiments, the compute instance 110 can be integrated with any number and/or types of other devices (e.g., one or more other compute instances and/or a display device) into a user device. Some examples of user devices include, without limitation, desktop computers, laptops, smartphones, tablets, and set-top boxes.

In general, each of the compute instance 110 and any number of other compute instances is configured to implement one or more software applications. For explanatory purposes only, each software application is described as residing in the memory 116 of a single compute instance and executing on the processor 112 of the same compute instance. However, in some embodiments, the functionality of each software application can be distributed across any number of other software applications that reside in the memories of any number of compute instances and execute on the processors of any number of compute instances in any combination. Further, subsets of the functionality of multiple software applications can be consolidated into a single software application.

In particular, the compute instance 110 is configured to encode video content or other media content via a media processing pipeline 130. As shown, in some embodiments, the media processing pipeline 130 encodes source media content 120 stored in the media database 104 to generate encoded media content 170 that is delivered to one or more client devices (not shown) via the CDN 190. The source media content 120 can be any portion of a video (e.g., a frame of a video), any portion (including all) of an image, or any other type of media content. The encoded media content 170 is an encoded version of the source media content 120.

The CDN 190 is a group of geographically distributed and interconnected servers that collectively stores and delivers encoded media content (e.g., the encoded media content 170) on behalf of the compute instance 110 to any number of client devices. Some examples of client devices include, without limitation, desktop computers, laptops, smartphones, smart televisions, game consoles, and tablets.

The media processing pipeline 130 implements any number and/or types of data compression techniques. In particular, the media processing pipeline 130 implements directional intra prediction from zone 2 to exploit spatial redundancy across the pixels of a given portion of video content along a prediction angle so that other data compression techniques can then be used to reduce the number of bits representing the portion of video content. Some examples of portions of video content, include, without limitation, at least a portion of a frame of a video or at least a portion of an image.

For explanatory purposes, the functionality of the media processing pipeline 130 is described herein the context of using directional intra prediction from zone 2 to generate a predicted macroblock of samples based on a left reference column of samples and an above reference row of samples in accordance with a target coding format. The target coding format is an exemplar block-based video coding format. A coding format is also commonly referred to as a compression format. Some examples of block-based video coding formats are AOMedia Video 1 (AV1), AOMedia Video 2 (AV2), and VP9.

As used herein, a macroblock represents a rectangular region of pixels and is associated with a portion of the content (e.g., the source media content 120) that corresponds to the rectangular region of pixels. A predicted macroblock of samples represents the same rectangular region of pixels as an associated macroblock and includes, without limitation, any number of samples corresponding to the rectangular region of pixels. As used herein, a “sample” is an intersection of a channel and a pixel. Some examples of channels include, without limitations, color or “chroma” channels and a brightness or “luma” channel. A sample that is the intersection of a luma channel and a pixel is also referred to herein as a “luma sample” associated with the pixel. A sample that is the intersection of a chroma channel and a pixel is also referred to herein as a chroma sample” associated with the pixel. A predicted macroblock of samples can contain a different two-dimensional (2D) array for each of any number of channels, and any number (including none) of the channels can be subsampled in any technically feasible fashion.

For instance, in some embodiments, the media processing pipeline 130 operates on media content in the YCbCr color space with no subsampling, where each macroblock represents a different 16×16 region of pixels. In the same or other embodiments, each predicted macroblock includes, without limitation, an array of 16×16 luma (Y) samples, an array of 16×16 Cb chroma samples, and an array of 16×16 Cr chroma samples.

In some alternate embodiments, the media processing pipeline 130 can use directional intra prediction from zone 2 when encoding any portion of video or other media content instead of a macroblock. In the same or other alternate embodiments, the media processing pipeline 130 can implement any number and/or types of data compression techniques in accordance with any type of coding format. The techniques described herein are modified accordingly.

As described previously herein, in one approach to encoding using directional intra prediction from zone 2, the media processing pipeline 130 partitions the pixels within the source media content 120 into rectangular blocks referred to as macroblocks. The macroblocks are sequentially encoded and decoded to generate, respectively, encoded macroblocks and reconstructed macroblocks. To encode a given macroblock, a reference row of samples and a left reference column of samples is determined based on any number of reconstructed macroblocks that are located, respectively, above and to the left of the given macroblock. For each row of pixels within the given macroblock, samples from the reference row and the left reference column are interpolated downwards and rightwards along a prediction angle to compute a row of samples within a predicted macroblock. Subsequently, various other data compression techniques are used to generate an encoded macroblock based on at least the predicted macroblock.

One drawback of the above approach to directional intra prediction from zone 2 is that the processing efficiencies typically captured through parallel processing can be substantially reduced. In that regard, because the samples in the left reference samples are typically stored in non-contiguous memory locations, any parallel processing operations used to generate a row within a predicted macroblock based on samples stored in the left reference column usually execute with degraded efficiency. As a result, overall encoding throughput can be decreased when performing intra directional processing from zone 2 on video content and other media content.

### Reorganizing Left Reference Samples into Contiguous Memory

To address the above problems, the compute instance 110 implements a directional intra prediction application 150 that reorganizes left reference samples into contiguous memory to facilitate parallel processing when performing directional intra prediction from zone 2. As used herein, “left reference samples” refer to samples that are initially stored in a left reference column.

For explanatory purposes, the directional intra prediction application 150 is described in the context of using directional intra prediction from zone 2 to generate a predicted macroblock of samples based on a left reference column of samples and an above reference row of samples in accordance with the target coding format described previously herein and without any chroma subsampling.

As persons skilled in the art will recognize, the techniques described herein are illustrative rather than restrictive and can be altered and applied in other contexts without departing from the broader spirit and scope of the inventive concepts described herein. For example, the techniques described herein can be modified and applied to any technically feasible coding format for video content or other media content (e.g., image content) and in any color space with any type (including none) of subsampling.

For instance, in some alternate embodiments, the techniques described herein can be applied when encoding any portion of content instead of a macroblock. In the same or other alternate embodiments, each predicted macroblock can be generated based on at least one portion of any number of columns of reference values and any portions of any number of rows of reference values. The techniques disclosed herein are modified accordingly.

As shown, the directional intra prediction application 150 resides in the memory 116 of the compute instance 110 and executes on the processor 112 of the compute instance 110. The directional intra prediction application 150 generates a predicted macroblock 156 based on a prediction angle 142, a macroblock 140, and a reference dataset 168. In accordance with the definition of directional intra prediction from zone 2, the prediction angle 142 is greater than 90 degrees and less than 180 degrees in a clockwise direction from a vertical direction.

As described previously herein, the macroblock 140 represents a rectangular region of pixels and is associated with a portion of content that corresponds to the rectangular regions of pixels. For explanatory purposes, the width (in pixels) of the macroblock 140 is denoted herein as W, the height (in pixels) of the macroblock 140 is denoted herein as H, and the dimensions of the macroblock 140 are therefore denoted herein as W×H.

Within the macroblock 140, the W different columns are at column indices that range from 0 through (W−1), and the H different rows are at row indices that range from 0 through (H−1). The column at the column index 0 corresponds to a leftmost column of the macroblock 140. The column at the column index (W−1) corresponds to a rightmost column of the macroblock 140. The row at the row index 0 corresponds to a top row of the macroblock 140. The row at the row index (H−1) corresponds to a bottom row of the macroblock 140.

At any given point-in-time, the reference dataset 168 includes, without limitation, any portions of any number of reconstructed macroblocks previously generated by the media processing pipeline 130. The directional intra prediction application 150 determines an above reference row of samples based on the bottom row(s) of any number (including zero) of reconstructed macroblocks that reside along a top boundary of the macroblock 140 in accordance with the target coding format. The directional intra prediction application 150 determines a left reference column of samples based on the rightmost column(s) of any number (including zero) of reconstructed macroblocks that reside along a left boundary of the macroblock 140 in accordance with the target coding format.

As persons skilled in the art will recognize, the target coding format can define how to determine the values for samples in the above reference row and the left reference column based on previously reconstructed macroblocks in any technically feasible fashion. In particular, depending on the position of the macroblock relative to other macroblocks in a frame or image and the order in which the media processing pipeline 130 processes the different macroblocks, there may be no reconstructed macroblocks that reside along the top and/or left boundaries of the macroblock 140. In these situations, one or more relevant reconstructed samples do not yet exist and are therefore unavailable to the directional intra prediction application 150. When relevant reconstructed samples are unavailable, the target coding format can define how to determine the values for associated samples in the above reference row and the left reference column in any technically feasible fashion.

As shown, the directional intra prediction application 150 includes, without limitation, a macroblock preprocessing engine 152 and a tile prediction engine 154. The macroblock preprocessing engine 152 transposes the left reference column of samples to generate a left reference row of samples. As described previously herein, the media processing pipeline 130 stores a column of samples in non-contiguous memory locations, but stores a row of samples in contiguous memory locations. Accordingly, unlike the left reference column of samples, the left reference row of samples is stored in contiguous memory locations.

For explanatory purposes, an “above reference row of samples,” a “left reference column of samples,” and a “left reference row of samples” are also referred to herein as, respectively, an “above reference row,” a “left reference column,” and a “left reference row.” Further, when the term a “reference row” is used herein without a qualifier, the term refers to an “above reference row” not a “left reference row.”

The macroblock preprocessing engine 152 computes a tile height/width (denoted herein as S) based on at least one of the height of the macroblock 140 or the width of the macroblock 140. The macroblock preprocessing engine 152 partitions the macroblock 140 into one or more square tiles. Each tile represents a different square region of pixels and has the dimensions of S×S. The macroblock preprocessing engine 152 can compute the tile height/width in any technically feasible fashion.

For instance, as part of an exemplar macroblock preprocessing process, if at least one of the width of the macroblock 140 or the height of the macroblock 140 is less than 16 pixels, then the macroblock preprocessing engine 152 sets the tile height/width to 8 pixels and partitions the macroblock 140 into one or more tiles that each represent a different 8×8 region of pixels. Otherwise, the macroblock preprocessing engine 152 sets the tile height/width to 16 pixels and partitions the macroblock 140 into one or more tiles that each represent a different 16×16 region of pixels.

After the macroblock preprocessing engine 152 finishes executing, the directional intra prediction application 150 causes the tile prediction engine 154 to generate a predicted tile of samples for each of the tiles in the macroblock 140. More specifically, for each tile in the macroblock, the directional intra prediction application 150 executes the tile prediction engine 154 on the tile, the above reference row, the left reference row, and the prediction angle 142 to generate a corresponding predicted tile of samples.

The tile prediction engine 154 computes a predicted tile of samples corresponding to a current tile within the macroblock 140 based on the above reference row, the left reference row, and the prediction angle 142. As described in greater detail below, the tile prediction engine 154 computes a downward predicted tile of samples based on the above reference row, the prediction angle 142, and the two-dimensional (2D) position of the current tile within the macroblock 140. The tile prediction engine 154 computes a transposed rightward predicted tile of samples based on the left reference row, the prediction angle 142, and the two-dimensional (2D) position of the current tile within the macroblock 140. The tile prediction engine 154 transposes the transposed rightward predicted tile to generate a rightward predicted tile of samples. The tile prediction engine 154 then generates a predicted tile of samples corresponding to the current tile based on the downward predicted tile of samples, the rightward predicted tile of samples, and the prediction angle 142.

For explanatory purposes, a “predicted tile of samples” is also referred to herein, as a “predicted tile.” Similarly, a “downward predicted tile of samples,” “a transposed rightward predicted tile of samples,” and a “rightward predicted tile of samples” are referred to herein, respectively, as a “downward predicted tile,” “a transposed rightward predicted tile,” and a “rightward predicted tile.”

The tile prediction engine 154 computes the downward predicted tile of samples based on the above reference row, the prediction angle 142, and the two-dimensional (2D) position of the current tile within the macroblock 140 in accordance with the target coding format. More precisely, the tile prediction engine 154 computes the downward predicted tile of samples based on underlying formulas that are defined by the target coding format and used to interpolate downwards along the prediction angle from the above reference row.

In accordance with the target coding format, the tile prediction engine 154 can execute any number and/or types of intra prediction operations (e.g., selection operation, weighted averaging operations, any number and/or types of other interpolation operations) on any portion (including all) of the above reference row to compute the downward predicted tile.

For instance, in some embodiments, the tile prediction engine 154 implements an exemplar intra prediction process. As per the exemplar intra prediction process, to compute a luma sample associated with a given pixel for inclusion in the downward predicted tile, the tile prediction engine 154 selects two luma samples from the above reference row based on the prediction angle 142 and the 2D position of the given pixel within the macroblock 140. The tile prediction engine 154 sets the luma sample equal to a weighted average of the selected luma samples.

Notably, in some embodiments, the tile prediction engine 154 computes at least some of the samples within the same row of the downward predicted tile in parallel in any technically feasible fashion. For instance, in some embodiments, the tile prediction engine 154 computes all of the samples for a row of the downward predicted tile in parallel using single instruction, multiple data (SIMD) instructions that operate on SIMD vectors that each contain 16 integers.

The tile prediction engine 154 computes the transposed rightward predicted tile based on the left reference row, the prediction angle 142, and the two-dimensional (2D) position of the current tile within the macroblock 140 in accordance with the target coding format. More precisely, the tile prediction engine 154 computes a transposed version of a rightward predicted tile using a transposed version of the left reference column based on the same underlying formulas that are defined by the target coding format and used in conventional implementations to interpolate rightwards along the prediction angle from the left reference column to compute the rightward predicted tile. As persons skilled in the art will recognize, computing a transposed rightward predicted tile in some embodiments can be considered equivalent to interpolating downwards along a “transposed prediction angle” from an associated left reference row. In the same or other embodiments, the transposed prediction angle is equal to (270 degrees—the prediction angle 142).

Consistent with the target coding format, the tile prediction engine 154 can execute any number and/or types of intra prediction operations (e.g., selection operations, weighted averaging operations, any number and/or types of other interpolation operations) on any portion (including none) of the left reference row to compute the transposed rightward predicted tile corresponding to the current tile.

For instance, in some embodiments, the tile prediction engine 154 implements the exemplar intra prediction process. As per the exemplar intra prediction process, to compute a luma sample associated with a given pixel for inclusion in the transposed rightward predicted tile, the tile prediction engine 154 selects two luma samples from the left reference row based on the prediction angle 142 and the 2D position of the given pixel within the macroblock 140. The tile prediction engine 154 sets the luma sample equal to a weighted average of the selected luma samples.

Notably, in some embodiments, the tile prediction engine 154 computes at least some of the samples within the same row of the transposed rightward predicted tile in parallel in any technically feasible fashion. For instance, in some embodiments, the tile prediction engine 154 computes all of the samples for a row of the transposed rightward predicted tile in parallel using single instruction, multiple data (SIMD) instructions that operate on SIMD vectors that each contain 16 integers.

Subsequently, the tile prediction engine 154 transposes the transposed rightward predicted tile to generate a rightward predicted tile that corresponds to the current tile. The tile prediction engine 154 then generates the predicted tile that corresponds to the current tile based on the downward predicted tile, the rightward predicted tile, and the prediction angle 142. The tile prediction engine 154 can generate the predicted tile based on the downward predicted tile, the rightward predicted tile, and the prediction angle 142 in any technically feasible fashion that is consistent with the target coding format.

For instance, in some embodiments, the tile prediction engine 154 implements the exemplar intra prediction process. As per the exemplar intra directional prediction process, for each of the S rows in the current tile, the tile prediction engine 154 determines a different “split” column index based on the prediction angle 142 and the position of the row within the macroblock 140.

If the split column index for a row at a current row index is zero, then the tile prediction engine 154 selects the entire row at the current row index in the downward predicted tile for inclusion in the predicted tile at the current row index and discards the entire row at the current row index in the rightward predicted tile. Otherwise, if the split column index for a current row index is S, then the tile prediction engine 154 selects the entire row at the current row index in the rightward predicted tile for inclusion in the predicted tile at the current row index and discards the entire row at the current row index in the downward predicted tile.

Otherwise, if the split column index for a row at a current row index is greater than 0 and less than S, then the tile prediction engine 154 selects a portion of the row at the current row index from the rightward predicted tile and selects a portion of the row at the current row index from the downward predicted tile based on the split column index. More specifically, the tile prediction engine 154 selects samples corresponding to the current row index and column indices from 0 through (split column index−1) from the rightward predicted tile. The tile prediction engine 154 selects samples corresponding to the current row index and column indices from the split column index through (S−1) from the downward predicted tile. The tile prediction engine 154 aggregates the selected samples from the rightward predicted tile and the selected samples from the downward predicted tile to generate a row of samples for inclusion in the predicted tile at the current row index.

The tile prediction engine 154 can compute the S split column indices for the rows 0 through S−1 in any technically feasible fashion. For instance, in some embodiments, the tile prediction engine 154 computes the S split columns indices based on the prediction angle 142 (denoted herein as prediction_angle) according to the following split column pseudocode (1):

```
// Split Column Pseudocode (1)
// Iterate over the S rows of a current tile representing a square region of
pixels
// that has a top left corner pixel at 2D position (j, r) within the macroblock
140,
// where 0 <= j < (W−S) and 0 <= r < (H−S)
for (int k = 0; k < S; ++k) {
  // Calculate a split column index for a current row index denoted as k
  int y = k + r + 1;
  real theta = 180 − prediction_angle;
  int dx = Dr_Intra_Derivative[theta];
  int base_x = ((j << 6) − y * dx) >> 6;
  int split_index = (−1 − base_x);
  if (split_index > S) {
    split_index = S;
  } else if (split_index < 0) {
    split_index = 0;
  }
```

The split column pseudocode (1) refers to an array dr_intra_derivative that is defined for values of theta corresponding to any number of prediction angles that are permitted by the target coding format. In some embodiments, the array dr_intra_derivative has the following definition (2):

// Definition of Array dr_intra_derivative (2)
static const int16_t dr_intra_derivative[90] = {
// Comments indicate theta in degrees
// Starred (*) values are unused

| | | | | | | |
|---|---|---|---|---|---|---|
| 0, | 4096, | 2048, | // | *, | 0.9, | 1.8, |
| 1365, | 1024, | 819, | // | 2.7, | 3.6, | 4.5, |
| 682, | 585, | 512, | // | 5.4, | 6.2, | 7.1, |
| 455, | 409, | 409, | // | 8.0, | 8.9, | *, |
| 409, | 372, | 341, | // | *, | 9.8, | 10.6, |
| 292, | 273, | 256, | // | 12.4, | 13.2, | 14.0, |
| 227, | 215, | 204, | // | 15.7, | 16.6, | 17.4, |
| 186, | 178, | 170, | // | 19.0, | 19.8, | 20.6, |
| 157, | 151, | 146, | // | 22.2, | 23.0, | 23.7, |
| 136, | 132, | 128, | // | 25.2, | 25.9, | 26.6, |
| 117, | 110, | 107, | // | 28.7, | 30.2, | 30.9, |
| 99, | 97, | 97, | // | 32.9, | *, | 33.4, |
| 93, | 87, | 83, | // | 34.5, | 36.3, | 37.6, |
| 81, | 77, | 74, | // | 38.3, | 39.7, | 40.9, |
| 73, | 69, | 66, | // | 41.2, | 42.8, | 44.1, |
| 64, | 62, | 59, | // | 45.0, | 45.9, | 47.3, |
| 56, | 55, | 53, | // | 48.8, | 49.3, | 50.4, |
| 50, | 49, | 47, | // | 52.0, | 52.6, | 53.7, |
| 44, | 42, | 42, | // | 55.5, | 56.7, | *, |
| 41, | 38, | 37, | // | 57.4, | 59.3, | 60.0, |
| 35, | 32, | 31, | // | 61.3, | 63.4, | 64.2, |
| 30, | 28, | 27, | // | 64.9, | 66.4, | 67.1, |
| 26, | 24, | 23, | // | 67.9, | 69.4, | 70.2, |
| 22, | 20, | 19, | // | 71.0, | 72.6, | 73.5, |
| 18, | 16, | 15, | // | 74.3, | 76.0, | 76.8, |
| 14, | 12, | 11, | // | 77.7, | 79.4, | 80.2, |
| 10, | 10, | 10, | // | *, | *, | 81.1, |
| 9, | 8, | 7, | // | 82.0, | 82.9, | 83.8, |
| 6, | 5, | 4, | // | 84.6, | 85.5, | 86.4, |
| 3, | 2, | 1, | // | 87.3, | 88.2, | 89.1 }; |

The directional intra prediction application 150 aggregates the predicted tiles corresponding to the tiles included in the macroblock 140 to generate the predicted macroblock 156 that includes samples corresponding to the rectangle region of pixels represented by the macroblock 140. Subsequently, the media processing pipeline 130 generates an encoded version of the macroblock 140 and a reconstructed macroblock 162 based, at least in part, on the predicted macroblock 156. The encoded version of the macroblock 140 is also referred to herein as an “encoded macroblock.” The reconstructed macroblock 162 is a reconstructed version of the macroblock 140. The media processing pipeline 130 can generate the encoded macroblock and the reconstructed macroblock 162 in any technically feasible fashion that is consistent with the target coding format.

As shown, the media processing pipeline 130 stores the reconstructed macroblock 162 in the media database 104. Subsequently, the media processing pipeline 130 can use the reconstructed macroblock 162 to determine top reference row(s) and/or left reference column(s) when encoding any number of other macroblocks. After the media processing pipeline 130 finishes encoding all macroblocks included in the source media content 120, the media processing pipeline 130 generates the encoded media content 170 based on the encoded versions of the macroblocks. As shown, the media processing pipeline 130 then transmits the encoded media content 170 to the CDN 190.

Advantageously, because the directional intra prediction application 150 reorganizes left reference samples into contiguous memory locations when performing intra directional prediction from zone 2 to compute a predicted macroblock, processing efficiencies can be increased via parallel processing relative to what can be achieved using prior art techniques. As a result, overall encoding throughput can be decreased when performing intra directional processing from zone 2 on video content and other media content (e.g., images).

It will be appreciated that the system 100 shown herein is illustrative and that variations and modifications are possible. For example, the functionality provided by the media processing pipeline 130 and the directional intra prediction application 150 as described herein can be integrated into or distributed across any number of software applications (including one), and any number of components of the system 100. Further, the connection topology between the various units in FIG. 1 can be modified as desired.

Please note that the techniques described herein are illustrative rather than restrictive and can be altered without departing from the broader spirit and scope of the embodiments. Many modifications and variations on the functionality of the compute instance 110, the media processing pipeline 130, the directional intra prediction application 150, the macroblock preprocessing engine 152, the tile prediction engine 154, and the CDN 190 as described herein will be apparent to those of ordinary skill in the art without departing from the scope and spirit of the described embodiments.

Similarly, the storage, organization, amount, and/or types of data described herein are illustrative rather than restrictive and can be altered without departing from the broader spirit and scope of the embodiments. In that regard, many modifications and variations on the source media content 120, the macroblock 140, the reference dataset 168, the prediction angle 142, the predicted macroblock 156, the tiles, the predicted tiles, the reconstructed macroblock 162, and the encoded media content 170 as described herein will be apparent to those of ordinary skill in the art without departing from the scope and spirit of the described embodiments.

### Exemplar Macroblock Preprocessing

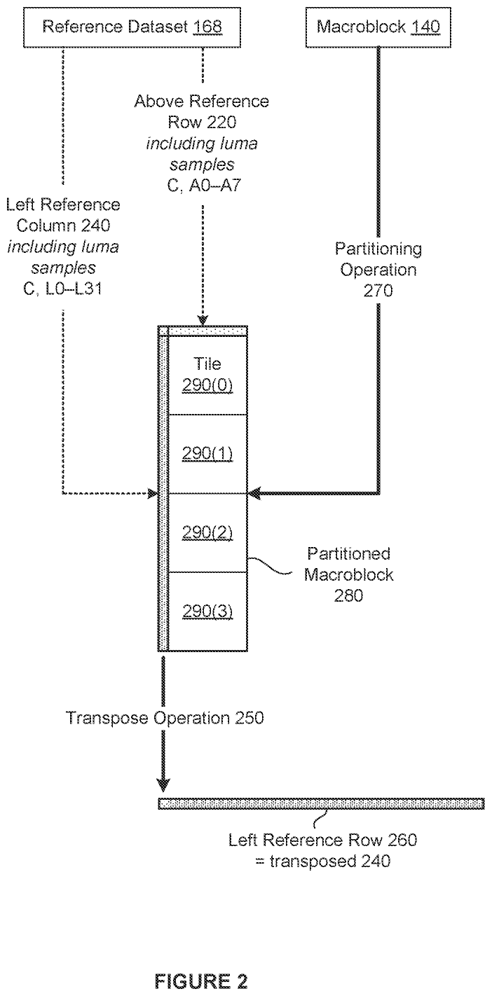

FIG. 2 is an exemplar illustration of a preprocessing process executed by the macroblock preprocessing engine 152 of FIG. 1, according to various embodiments. For explanatory purposes, the macroblock preprocessing engine 152 executes the exemplar preprocessing process described previously herein in conjunction with FIG. 1 on an example of the macroblock 140 that has a width of 8 pixels and a height of 32 pixels based on the reference dataset 168.

As described previously herein in conjunction with FIG. 1, the reference dataset 168 includes, without limitation, any number (including zero) of reconstructed macroblocks. The macroblock preprocessing engine 152 determines an above reference row 220 based on the bottom row(s) of any number (including zero) of reconstructed macroblocks that reside along a top boundary of the macroblock 140 in accordance with the target coding format. For explanatory purposes luma samples included in the above reference row 220 are denoted from left to right as C, A0, A1, A2, A3, A4, A5, A6, and A, where C denotes a corner luma sample. Chroma samples are not shown in FIG. 2.

As shown, the macroblock preprocessing engine 152 determines a left reference column 240 based on the rightmost row(s) of any number (including zero) of reconstructed macroblocks that reside along a left boundary of the macroblock 140 in accordance with the target coding format. For explanatory purposes, luma samples included in the left reference column 240 are denoted from left to right as C, L0-L31, where the corner luma sample C is also included in the above reference row 220.

As shown, the macroblock preprocessing engine 152 executes a transpose operation 250 on the left reference column 240 to generate a left reference row 260. Notably, while the left reference column 240 stores the luma samples C, L0-L31 in non-contiguous memory locations, the left reference row 260 stores the same luma samples C, L0-L31 in contiguous memory locations.

As described previously herein, the macroblock preprocessing engine 152 computes a tile height/width (not shown) based on the width and the height of the macroblock 140. As per the exemplar preprocessing process described previously herein in conjunction with FIG. 1, because the width of the macroblock 140 is less than 16 pixels, the macroblock preprocessing engine 152 sets the tile height/width equal to 8 pixels.

As shown, the macroblock preprocessing engine 152 performs a partitioning operation 270 on the macroblock 140 based on the tile height/width of 8 pixels to generate a partitioned macroblock 280. For explanatory purposes, as used herein, 2D positions of pixels represented by the partitioned macroblock 280 are specified as 2D coordinates (x, y) with respect to the partitioned macroblock 280. Accordingly, the top-left corner pixel represented by the partitioned macroblock 280 has a 2D position of (0, 0) and the bottom-right corner pixel represented by the partitioned macroblock 280 has a 2D position of (7, 31).

As shown, the partitioned macroblock includes a tile 290(0), a tile 290(1), a tile 290(2), and a tile 290(3). The tile 290(0) represents an 8×8 square region of pixels having a top-left corner pixel at a 2D position (0, 0). The tile 290(1) represents an 8×8 square region of pixels having a top-left corner pixel at a 2D position (0, 8). The tile 290(2) represents an 8×8 square region of pixels having a top-left corner pixel at a 2D position (0, 16). The tile 290(3) represents an 8×8 square region of pixels having a top-left corner pixel at a 2D position (0, 24).

### Exemplar Directional Intra Prediction from Zone 2

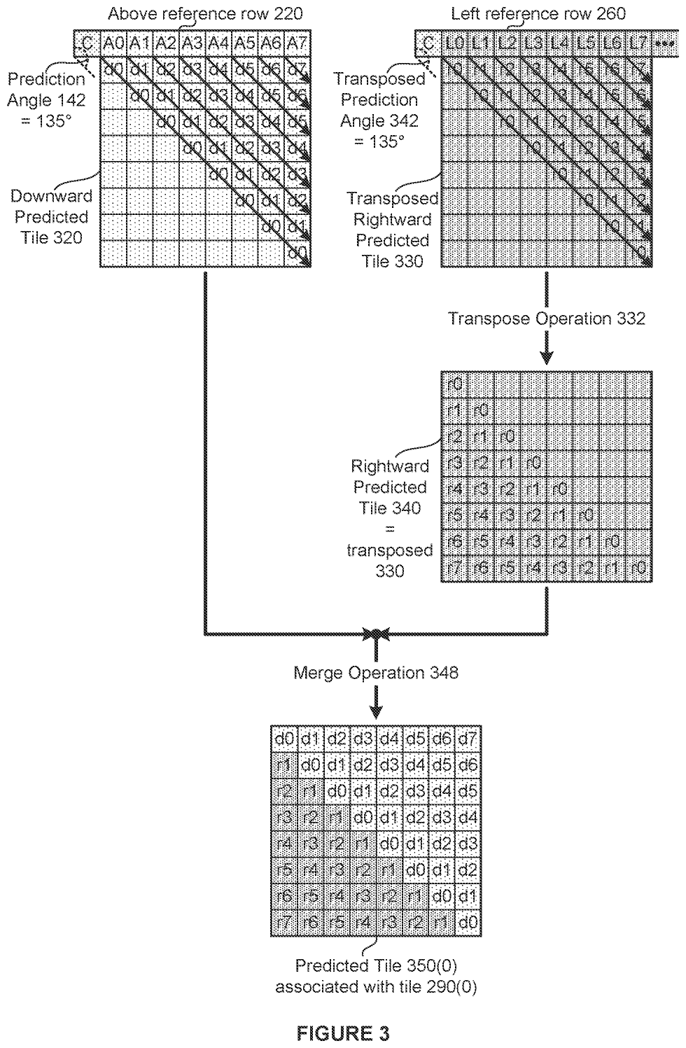

FIG. 3 is an exemplar illustration of a directional intra prediction process executed by the tile prediction engine 154 of FIG. 1, according to various embodiments. For explanatory purposes, the tile prediction engine 154 performs the exemplar intra prediction process described previously herein in conjunction with FIG. 1 to generate a predicted tile 350(0, 0) for the content represented by the tile 290(0) of FIG. 2 based on the prediction angle 142 of 135 degrees (135°).

As described previously herein in conjunction with FIG. 2, the tile 290(0) represents an 8×8 square region of pixels and the prediction angle 142 is measured in a clockwise direction from a vertical direction. Notably, because the prediction angle 142 is greater than 90 degrees and less than 180 degrees, the exemplar directional intra prediction process is from zone 2.

As shown, the tile prediction engine 154 generates a downward predicted tile 320 based on the prediction angle 142 and the above reference row 220 associated with the macroblock 140. As shown and as described previously herein in conjunction with FIG. 2, the above reference row 220 includes, without limitation, luma samples denoted C, A0, A1, A2, A3, A4, A5, A6, and A7 and any number (including none) of samples associated with other channels (not shown). As per the exemplar directional intra prediction process described previously herein, the tile prediction engine 154 sequentially generates each row of the downward predicted tile 320 based on the prediction angle 142 and the above reference row 220 in accordance with the target coding format. More precisely, the tile prediction engine 154 interpolates downwards along the prediction angle 142 of 135 degrees from the above reference row 220 to generate the downward predicted tile 320.

For explanatory purposes only, some luma samples included in the downward predicted tile 320 are annotated with lowercase labels d0-d8, where luma samples annotated with the same lowercase labels have the same value. Although not shown, other luma samples and any number (including none) of samples associated with other channels are included in the downward predicted tile 320. Notably, the groups of samples corresponding to each of the lowercase labels d0-d8 are aligned along different diagonal lines that are at the prediction angle 142 from a vertical direction.

As shown, in some embodiments, the tile prediction engine 154 sets eight luma samples that lie along the leftmost diagonal line within the downward predicted tile 320 to do, where do is a weighted average of C and A0. The tile prediction engine 154 sets seven luma samples that lie along the next diagonal line within the downward predicted tile 320 to d1, where d1 is a weighted average of A0 and A1. The tile prediction engine 154 sets six luma samples that lie along the next diagonal line within the downward predicted tile 320 to d2, where d2 is a weighted average of A1 and A2. The tile prediction engine 154 sets five luma samples that lie along the next diagonal line within the downward predicted tile 320 to d3, where d3 is a weighted average of A2 and A3. The tile prediction engine 154 sets four luma samples that lie along the next diagonal line within the downward predicted tile 320 to d4, where d4 is a weighted average of A3 and A4. The tile prediction engine 154 sets three luma samples that lie along the next diagonal line within the downward predicted tile 320 to d5, where d5 is a weighted average of A4 and A5. The tile prediction engine 154 sets two luma samples that lie along the next diagonal line within the downward predicted tile 320 to d6, where d6 is a weighted average of the sample values A5 and A6. The tile prediction engine 154 sets one luma sample that lies along the rightmost diagonal line within the downward predicted tile 320 to d7, where d7 is a weighted average of the sample values A6 and A7.

As shown, the tile prediction engine 154 generates a transposed rightward predicted tile 330 based on the prediction angle 142 and the left reference row 260 associated with the macroblock 140. As shown and as described previously herein in conjunction with FIG. 2, the left reference row 260 includes, without limitation, luma samples denoted C, L0-L31 and any number (including none) of samples associated with other channels (not shown). As per the exemplar directional intra prediction process, the tile prediction engine 154 sequentially generates each row of the transposed rightward predicted tile 330 based on the prediction angle 142 and the left reference row 260 in accordance with the target coding format.

As illustrated, the tile prediction engine 154 can be considered to interpolate downwards along a transposed prediction angle 342 from the left reference row 260 to generate the transposed rightward predicted tile 330. As described previously herein in conjunction with FIG. 1, the transposed prediction angle 342 is equal to 270 degrees—the prediction angle 142 and is therefore 135 degrees.

For explanatory purposes only, some luma samples included in the transposed rightward predicted tile 330 are annotated with lowercase labels r0-r8, where luma samples annotated with the same lowercase labels have the same value. Although not shown, other luma samples and any number (including none) of samples associated with other channels are included in the transposed rightward predicted tile 330. Notably, the groups of samples corresponding to each of the lowercase labels r0-r8 are aligned along different diagonal lines that are at the transposed prediction angle 342 from a vertical direction.

As shown, in some embodiments, the tile prediction engine 154 sets eight luma samples that lie along the leftmost diagonal line within the transposed rightward predicted tile 330 to r0, where r0 is a weighted average of C and L0. The tile prediction engine 154 sets seven luma samples that lie along the next diagonal line within the transposed rightward predicted tile 330 to r1, where r1 is a weighted average of L0 and L1. The tile prediction engine 154 sets six luma samples that lie along the next diagonal line within the transposed rightward predicted tile 330 to r2, where r2 is a weighted average of L1 and L2. The tile prediction engine 154 sets five luma samples that lie along the next diagonal line within the transposed rightward predicted tile 330 to r3, where r3 is a weighted average of L2 and L3. The tile prediction engine 154 sets four luma samples that lie along the next diagonal line within the transposed rightward predicted tile 330 to r4, where r4 is a weighted average of L3 and L4. The tile prediction engine 154 sets three luma samples that lie along the next diagonal line within the transposed rightward predicted tile 330 to r5, where r5 is a weighted average of L4 and L5. The tile prediction engine 154 sets two luma samples that lie along the next diagonal line within the transposed rightward predicted tile 330 to r6, where r6 is a weighted average of the sample values L5 and L6. The tile prediction engine 154 sets one luma sample that lies along the rightmost diagonal line within the transposed rightward predicted tile 330 to r7, where r7 is a weighted average of the sample values L6 and L7.

As shown, the tile prediction engine 154 performs a transpose operation 332 on the transposed rightward predicted tile 330 to generate a rightward predicted tile 340. For explanatory purposes, transposed versions of the luma samples that are annotated with lowercase labels r0-r8 within the transposed rightward predicted tile 330 are annotated in the same fashion in the rightward predicted tile 340.

As shown, the tile prediction engine 154 performs a merge operation 348 on the downward predicted tile 320 and the rightward predicted tile 340 to generate a predicted tile 350(0) that is associated with the tile 290(0). More specifically, as per the exemplar directional intra prediction process described previously herein in conjunction with FIG. 1 the predicted tile 350(0) includes samples for the square pixel region represented by the tile 290(0).

In some embodiments, to perform the merge operation 348, the tile prediction engine 154 computes S split column indices of 0-7 for, respectively, row indices 0-7 in accordance with the split column pseudocode pseudocode (1) and the definition (2) of FIG. 1. The tile prediction engine 154 therefore selects the entire row at row index 0 from the downward predicted tile 320 for inclusion in the predicted tile 350(0) at row index 0. For each of the remaining row indices k, where k ranges from 1 through 7, the tile prediction engine 154 selects a portion of the row at row index k from the downward predicted tile 320 and selects a portion of the row at row index k from the rightward predicted tile 340. The tile prediction engine 154 aggregates the selected portions to generate a row for inclusion in the predicted tile 350(0) at row index k.

As shown, the tile prediction engine 154 therefore sets the luma samples included in row 0 of the predicted tile 350(0) equal to d0-d7. The tile prediction engine 154 sets the luma samples included in row 1 of the predicted tile 350(0) equal to r1, do-d6. The tile prediction engine 154 sets the luma samples included in row 2 of the predicted tile 350(0) equal to r2-r1, d0-d5. The tile prediction engine 154 sets the luma samples included in row 3 of the predicted tile 350(0) equal to r3-r1, d0-d4. The tile prediction engine 154 sets the luma samples included in row 4 of the predicted tile 350(0) equal to r4-r1, d0-d3. The tile prediction engine 154 sets the luma samples included in row 5 of the predicted tile 350(0) equal to r5-r1, d0-d2. The tile prediction engine 154 sets the luma samples included in row 6 of the predicted tile 350(0) equal to r5-r1, d1-d0. And the tile prediction engine 154 sets the luma samples included in row 7 of the predicted tile 350(0) equal to r6-r1, do.

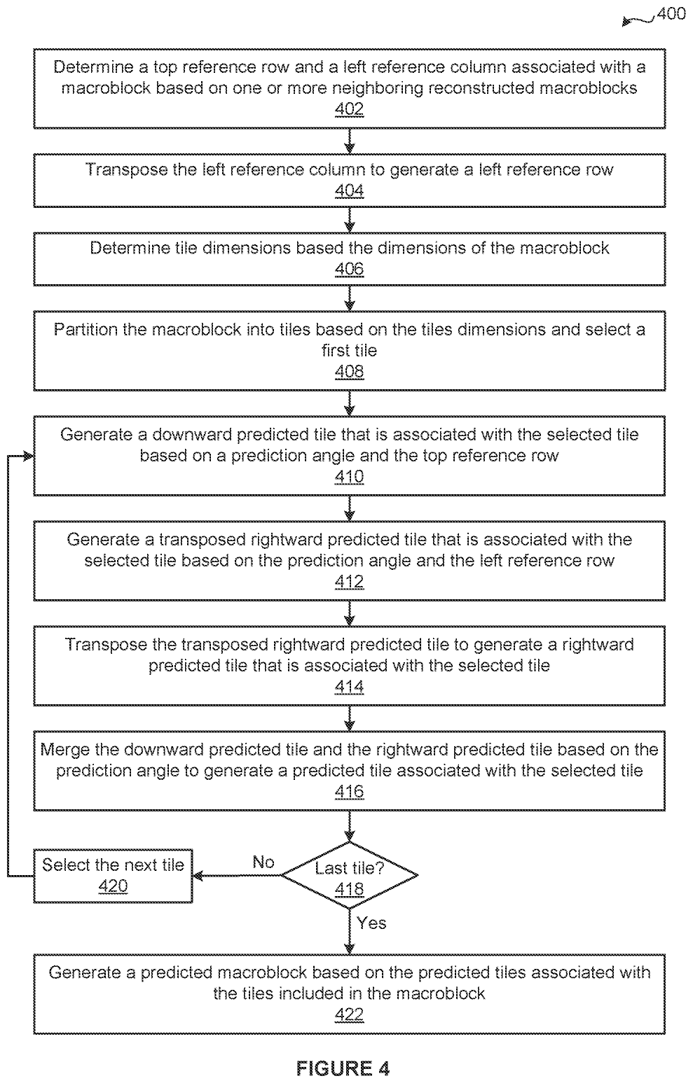

FIG. 4 is a flow diagram of method steps for performing directional intra prediction from zone 2 when encoding video or other media content, according to various embodiments. Although the method steps are described with reference to the systems of FIGS. 1-3, persons skilled in the art will understand that any system configured to implement the method steps, in any order, falls within the scope of the present invention.

As shown, a method 400 begins at step 402, where the macroblock preprocessing engine 152 determines a top reference row and a left reference column associated with a macroblock based on one or more neighboring reconstructed macroblocks. At step 404, the macroblock preprocessing engine 152 transposes the left reference column to generate a left reference row.

At step 406, the macroblock preprocessing engine 152 determines tile dimensions based on the dimensions of the macroblock. At step 408, the macroblock preprocessing engine 152 partitions the macroblock into tiles based on the tile dimensions and selects a first tile.

At step 410, the tile prediction engine 154 generates a downward predicted tile that is associated with the selected tile based on a prediction angle and the top reference row. At step 412, the tile prediction engine 154 generates a transposed rightward predicted tile that is associated with the selected tile based on the prediction angle and the left reference row. At step 414, the tile prediction engine 154 transposes the transposed rightward predicted tile to generate a rightward predicted tile that is associated with the selected tile. At step 416, the tile prediction engine 154 merges the downward predicted tile and the rightward predicted tile based on the prediction angle to generate a predicted tile associated with the selected tile.

At step 418, the directional intra prediction application 150 determines whether the selected tile is the last tile included in the macroblock. If, at step 418, the directional intra prediction application 150 determines that the selected tile is not the last tile included in the macroblock, then the method 400 proceeds to step 420. At step 420, the directional intra prediction application 150 selects a next tile. The method 400 then returns to step 410, where the tile prediction engine 154 generates a downward predicted tile that is associated with the selected tile.

If, however, at step 418, the directional intra prediction application 150 determines that the selected tile is the last tile included in the macroblock, then the method 400 proceeds directly to step 422. At step 422, the directional intra prediction application 150 generates a predicted macroblock based on the predicted tiles associated with the tiles included in the macroblock. The method 400 then terminates.

In sum, the disclosed techniques can be used to perform directional intra prediction from zone 2 when encoding video or other media content. In some embodiments, a directional intra prediction application generates a predicted macroblock corresponding to a current macroblock based on any number of reconstructed macroblocks and a prediction angle. The direction intra prediction application includes a macroblock preprocessing engine and a tile prediction engine. The macroblock preprocessing engine determines an above reference row and a left reference column based on the position of the current macroblock relative to any reconstructed macroblocks. The macroblock preprocessing engine transposes the left reference column to generate a left reference row. If at least one of the height or width of the macroblock exceeds 16, then the macroblock preprocessing engine partitions the macroblock into 16×16 tiles. Otherwise, the macroblock preprocessing engine partitions the macroblock into 8×8 tiles. The macroblock preprocessing engine configures the tile prediction engine to generate a different predicted tile for each tile included in the macroblock based on the prediction angle, the above reference row, and the left reference row. The macroblock preprocessing engine aggregates the predicted tiles to generate a predicted macroblock that is subsequently used to generate an encoded macroblock corresponding to the current macroblock.

The tile prediction engine performs direction intra prediction on a current tile to generate a corresponding predicted tile. For each row in the current tile, the tile prediction engine concurrently predicts samples for a corresponding row in a downward predicted tile based on the prediction angle and the above reference row. For each row in the current tile, the tile prediction engine concurrently predicts samples for a corresponding row in a transposed rightward predicted tile based on the prediction angle and the left reference row. The tile prediction engine transposes the transposed rightward predicted tile to generate a rightward predicted tile. The tile prediction engine merges the downward predicted tile and the transposed rightward predicted tile based on the prediction angle to generate the predicted tile corresponding to the current tile.

At least one technical advantage of the disclosed techniques relative to the prior art is that, with the disclosed techniques, samples within a left reference column used to encode a given macroblock are reorganized into contiguous locations in memory to facilitate parallel processing when performing directional intra prediction from zone 2. In that regard, prior to computing a predicted macroblock, a left reference column associated with a given macroblock being encoded is automatically transposed to generate a left reference row. Because the samples within the left reference row can be stored in contiguous memory, processing efficiencies can be increased via parallel processing relative to what can be achieved using prior art techniques to compute the predicted macroblock. As a result, the disclosed techniques can increase overall encoding throughput when performing directional intra directional processing from zone 2 on video content or other media content. These technical advantages provide one or more technological advancements over prior art approaches.
1. In some embodiments, a computer-implemented method for encoding video or other media content comprises transposing a left reference column of samples associated with a first portion of content to generate a left reference row of samples; computing a transposed rightward predicted tile of samples based on a prediction angle and the left reference row of samples; transposing the transposed rightward predicted tile to generate a rightward predicted tile of samples; and generating a predicted tile of samples for the first portion of content based on a downward predicted tile of samples and the rightward predicted tile of samples.
2. The computer-implemented method of clause 1, wherein computing the transposed rightward predicted tile of samples comprises executing one or more intra prediction operations on at least a portion of the left reference row of samples based on the prediction angle to generate a first row of samples.
3. The computer-implemented method of clauses 1 or 2, further comprising computing the downward predicted tile of samples based on the prediction angle and a reference row of samples associated with the first portion of content.
4. The computer-implemented method of any of clauses 1-3, wherein the prediction angle is greater than 90 degrees and less than 180 degrees in a clockwise direction from a vertical direction.
5. The computer-implemented method of any of clauses 1-3, further comprising selecting a first portion of a first row of samples from the rightward predicted tile of samples and a second portion of a second row of samples from the downward predicted tile of samples based on the prediction angle; and aggregating the first portion of the first row of samples and the second portion of the second row of samples to generate a third row of samples for inclusion in the predicted tile of samples;
6. The computer-implemented method of any of clauses 1-5, further comprising selecting a third portion of a fourth row of samples from the rightward predicted tile of samples and a fourth portion of a fifth row of samples from the downward predicted tile of samples based on the prediction angle; and aggregating the third portion of the fourth row of samples and the fourth portion of the fifth row of samples to generate a sixth row of samples for inclusion in the predicted tile of samples.
7. The computer-implemented method of any of clauses 1-6, wherein the predicted tile of samples corresponds to a first tile representing a first square region of pixels.
8. The computer-implemented method of any of clauses 1-7, wherein the first portion of content represents a first rectangular region of pixels, and further comprising partitioning the first portion of content into a plurality of tiles based on at least one of a height of the first rectangular region of pixels or a width of the first rectangular region of pixels.
9. The computer-implemented method of any of clauses 1-8, further comprising determining the left reference column of samples based on one or more reconstructed portions of content that reside along a left boundary of the first portion of content.
10. The computer-implemented method of any of clauses 1-9, further comprising generating an encoded version of the first portion of content based on the predicted tile.
11. In some embodiments, one or more non-transitory computer readable media include instructions that, when executed by one or more processors, cause the one or more processors to encode video or other media content by performing the steps of transposing a left reference column of samples associated with a first portion of content to generate a left reference row of samples; computing a transposed rightward predicted tile of samples based on a prediction angle and the left reference row of samples; transposing the transposed rightward predicted tile to generate a rightward predicted tile of samples; and generating a predicted tile of samples for the first portion of content based on a downward predicted tile of samples and the rightward predicted tile of samples.
12. The one or more non-transitory computer readable media of clause 11, wherein computing the transposed rightward predicted tile of samples comprises executing one or more intra prediction operations on at least a portion of the left reference row of samples based on the prediction angle to generate a first row of samples.
13. The one or more non-transitory computer readable media of clauses 11 or 12, further comprising executing one or more intra prediction operations on at least a portion of a reference row of samples associated with the first portion of content based on the prediction angle to generate a first row of samples.
14. The one or more non-transitory computer readable media of any of clauses 11-13, wherein the prediction angle is greater than 90 degrees and less than 180 degrees in a clockwise direction from a vertical direction.
15. The one or more non-transitory computer readable media of any of clauses 11-14, further comprising selecting a first portion of a first row of samples from the rightward predicted tile of samples and a second portion of a second row of samples from the downward predicted tile of samples based on the prediction angle; and aggregating the first portion of the first row of samples and the second portion of the second row of samples to generate a third row of samples for inclusion in the predicted tile of samples.
16. The one or more non-transitory computer readable media of any of clauses 11-15, further comprising selecting a fourth row of samples from the rightward predicted tile of samples for inclusion in the predicted tile of samples at a second row index based on the prediction angle.
17. The one or more non-transitory computer readable media of any of clauses 11-16, wherein the predicted tile of samples corresponds to a first tile representing a first square region of pixels.
18. The one or more non-transitory computer readable media of any of clauses 11-17, wherein the first portion of content represents a first rectangular region of pixels, and further comprising partitioning the first portion of content into a plurality of tiles based on at least one of a height of the first rectangular region of pixels or a width of the first rectangular region of pixels.
19. The one or more non-transitory computer readable media of any of clauses 11-18, further comprising computing a second transposed rightward predicted tile of samples based on the prediction angle and the left reference row of samples; transposing the second transposed rightward predicted tile to generate a second rightward predicted tile of samples; and generating a second predicted tile of samples for the first portion of content based on a second downward predicted tile of samples and the second rightward predicted tile of samples.
20. In some embodiments, a system comprises one or more memories storing instructions and one or more processors coupled to the one or more memories that, when executing the instructions, perform the steps of transposing a left reference column of samples associated with a first portion of content to generate a left reference row of samples; computing a transposed rightward predicted tile of samples based on a prediction angle and the left reference row of samples; transposing the transposed rightward predicted tile to generate a rightward predicted tile of samples; and generating a predicted tile of samples for the first portion of content based on a downward predicted tile of samples and the rightward predicted tile of samples.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory, Flash memory, an optical fiber, a portable compact disc read-only memory, an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for encoding video or other media content, the method comprising:
transposing a left reference column of samples associated with a first portion of content to generate a left reference row of samples;
computing a transposed rightward predicted tile of samples based on a prediction angle and the left reference row of samples;
transposing the transposed rightward predicted tile to generate a rightward predicted tile of samples; and
generating a predicted tile of samples for the first portion of content based on a downward predicted tile of samples and the rightward predicted tile of samples.

2. The computer-implemented method of claim 1, wherein computing the transposed rightward predicted tile of samples comprises executing one or more intra prediction operations on at least a portion of the left reference row of samples based on the prediction angle to generate a first row of samples.

3. The computer-implemented method of claim 1, further comprising computing the downward predicted tile of samples based on the prediction angle and a reference row of samples associated with the first portion of content.

4. The computer-implemented method of claim 1, wherein the prediction angle is greater than 90 degrees and less than 180 degrees in a clockwise direction from a vertical direction.

5. The computer-implemented method of claim 1, further comprising:
selecting a first portion of a first row of samples from the rightward predicted tile of samples and a second portion of a second row of samples from the downward predicted tile of samples based on the prediction angle; and
aggregating the first portion of the first row of samples and the second portion of the second row of samples to generate a third row of samples for inclusion in the predicted tile of samples.

6. The computer-implemented method of claim 5, further comprising:
selecting a third portion of a fourth row of samples from the rightward predicted tile of samples and a fourth portion of a fifth row of samples from the downward predicted tile of samples based on the prediction angle; and
aggregating the third portion of the fourth row of samples and the fourth portion of the fifth row of samples to generate a sixth row of samples for inclusion in the predicted tile of samples.

7. The computer-implemented method of claim 1, wherein the predicted tile of samples corresponds to a first tile representing a first square region of pixels.

8. The computer-implemented method of claim 1, wherein the first portion of content represents a first rectangular region of pixels, and further comprising partitioning the first portion of content into a plurality of tiles based on at least one of a height of the first rectangular region of pixels or a width of the first rectangular region of pixels.

9. The computer-implemented method of claim 1, further comprising determining the left reference column of samples based on one or more reconstructed portions of content that reside along a left boundary of the first portion of content.

10. The computer-implemented method of claim 1, further comprising generating an encoded version of the first portion of content based on the predicted tile.

11. One or more non-transitory computer readable media including instructions that, when executed by one or more processors, cause the one or more processors to encode video or other media content by performing the steps of:
transposing a left reference column of samples associated with a first portion of content to generate a left reference row of samples;
computing a transposed rightward predicted tile of samples based on a prediction angle and the left reference row of samples;
transposing the transposed rightward predicted tile to generate a rightward predicted tile of samples; and
generating a predicted tile of samples for the first portion of content based on a downward predicted tile of samples and the rightward predicted tile of samples.

12. The one or more non-transitory computer readable media of claim 11, wherein computing the transposed rightward predicted tile of samples comprises executing one or more intra prediction operations on at least a portion of the left reference row of samples based on the prediction angle to generate a first row of samples.

13. The one or more non-transitory computer readable media of claim 11, further comprising executing one or more intra prediction operations on at least a portion of a reference row of samples associated with the first portion of content based on the prediction angle to generate a first row of samples.

14. The one or more non-transitory computer readable media of claim 11, wherein the prediction angle is greater than 90 degrees and less than 180 degrees in a clockwise direction from a vertical direction.

15. The one or more non-transitory computer readable media of claim 11, further comprising:
selecting a first portion of a first row of samples from the rightward predicted tile of samples and a second portion of a second row of samples from the downward predicted tile of samples based on the prediction angle; and
aggregating the first portion of the first row of samples and the second portion of the second row of samples to generate a third row of samples for inclusion in the predicted tile of samples.

16. The one or more non-transitory computer readable media of claim 15, further comprising selecting a fourth row of samples from the rightward predicted tile of samples for inclusion in the predicted tile of samples at a second row index based on the prediction angle.

17. The one or more non-transitory computer readable media of claim 11, wherein the predicted tile of samples corresponds to a first tile representing a first square region of pixels.

18. The one or more non-transitory computer readable media of claim 11, wherein the first portion of content represents a first rectangular region of pixels, and further comprising partitioning the first portion of content into a plurality of tiles based on at least one of a height of the first rectangular region of pixels or a width of the first rectangular region of pixels.

19. The one or more non-transitory computer readable media of claim 11, further comprising:
computing a second transposed rightward predicted tile of samples based on the prediction angle and the left reference row of samples;
transposing the second transposed rightward predicted tile to generate a second rightward predicted tile of samples; and
generating a second predicted tile of samples for the first portion of content based on a second downward predicted tile of samples and the second rightward predicted tile of samples.

20. A system comprising:
one or more memories storing instructions; and
one or more processors coupled to the one or more memories that, when executing the instructions, perform the steps of:
transposing a left reference column of samples associated with a first portion of content to generate a left reference row of samples;
computing a transposed rightward predicted tile of samples based on a prediction angle and the left reference row of samples;
transposing the transposed rightward predicted tile to generate a rightward predicted tile of samples; and
generating a predicted tile of samples for the first portion of content based on a downward predicted tile of samples and the rightward predicted tile of samples.
